(19) United States
(12) Patent Application Publication
(10) Pub. No.: US 2011/0146824 A1
(43) Pub. Date: Jun. 23, 2011

(54) CONTROL SYSTEM OF A SHIFT CYLINDER

(75) Inventors: Armin Brentel, Eriskirch (DE); Robert Ingenbleek, Kressbronn (DE); Mario Steinborn, Friedrichshafen (DE); Markus Ulbricht, Tettnang (DE)

(73) Assignee: ZF FRIEDRICHSHAFEN AG, Friedrichshafen (DE)

(21) Appl. No.: 12/377,956

(22) PCT Filed: Aug. 20, 2007
(86) PCT No.: PCT/EP2007/058608

§ 371 Date: Mar. 5, 2009

(30) Foreign Application Priority Data
Aug. 26, 2006 (DE) 10 2006 040 137.9

(51) Int. Cl. F16K 11/20

(52) U.S. Cl. 137/637

(57) ABSTRACT

A control system for a pneumatically or hydraulically actuated shift cylinder of a transmission or transmission-related auxiliary drive output, namely, for controlling at least one valve associated with the shift cylinder, such that each shift position of the shift cylinder can be produced. The control system includes: a) devices of a first type with which valve requirements corresponding to a plurality of functions demanded from the shift cylinder can be calculated at the same time, or in parallel, for the valve; b) devices of a second type which logically link the valve requirements calculated for the valve individually for each valve so that, from the valve requirements calculated in parallel for the respective valve, the devices of the second type determine an effective control measure for the valve concerned.

This application is a National Stage completion of PCT/EP2007/058608 filed Aug. 20, 2007, which claims priority from German Patent application serial no. 10 2006 040 137.9 filed Aug. 26, 2006.

### FIELD OF THE INVENTION

The invention concerns a control system for a pneumatically or hydraulically actuated shift cylinder of a transmission or a transmission-related auxiliary drive output.

### BACKGROUND OF THE INVENTION

In motor vehicle transmissions and transmission-related auxiliary drive outputs, pneumatically or hydraulically actuated shift elements in the form of shift cylinders are used for controlling or regulating the operation of the transmission or transmission-related auxiliary drive output. With each shift cylinder is associated at least one valve, such that the shift position of the shift cylinder is influenced and can therefore be adjusted by means of the valve or valves. In other words, the manner in which the shift cylinder is acted upon by a pneumatic or hydraulic pressure medium can be varied by means of the valve or valves, so as to move the shift cylinder to a desired shift position. Depending on the function demanded from the shift cylinder, the valve or valves associated with the shift cylinder is/are controlled with the help of a control system, in such manner that in accordance with common practice functions demanded from a shift cylinder can be implemented exclusively in sequence. Owing to this sequential implementation of the functions demanded, function gaps can occur. Moreover, overlaps between different functions demanded are not possible. This restricts the functionality of the shift cylinder.

With this situation as the point of departure, the present invention addresses the problem of providing a new type of control system for a pneumatically or hydraulically actuated shift cylinder of a transmission or transmission-related auxiliary drive output, with which on the one hand function gaps are avoided and on the other hand overlaps of the functions demanded are enabled.

### SUMMARY OF THE INVENTION

This problem is solved by a control system according to Claim 1. The control system according to the invention comprises: a) devices of a first type, with which corresponding valve requirements for the, or for each shift cylinder valve can be calculated at the same time or in parallel for a plurality of shift cylinder function demands; b) devices of a second type, which logically link the valve requirements for the, or for each shift cylinder valve individually for each valve, such that the said second-type devices determine, from the valve requirements calculated in parallel for the valve concerned, an effective control measure for each of the said valves.

Thanks to the simultaneous or parallel processing of several function demands the control system according to the invention for a shift cylinder avoids function gaps in the control of the, or of each shift cylinder valve and furthermore enables overlaps of function demands during the control of the, or of each shift cylinder valve.

### BRIEF DESCRIPTION OF THE DRAWINGS

Preferred further developments of the invention emerge from the subordinate claims and from the description given below. Example embodiments of the invention, to which it is not limited, are explained in more detail with reference to the attached drawing, which shows:

FIG. 1: A preferred example embodiment of a control system according to the invention for a pneumatically or hydraulically actuated shift cylinder with two chambers;

### DETAILED DESCRIPTION OF THE PREFERRED EMBODIMENTS

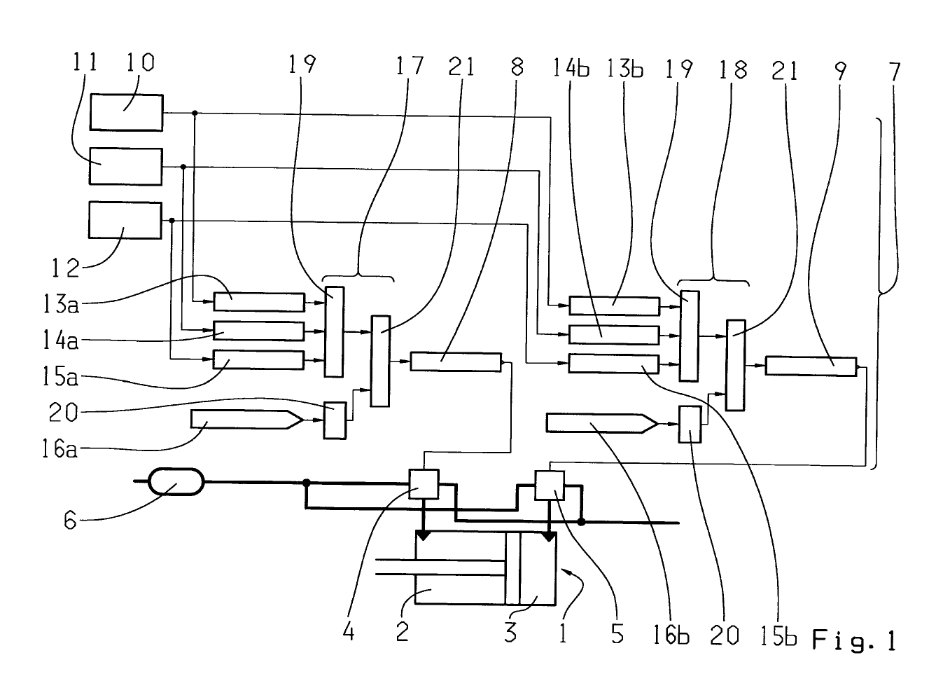

Below, with reference to FIG. 1 the present invention is described considering the example of a control system for a pneumatically actuated shift cylinder 1, the shift cylinder 1 having two chambers 2 and 3 for a pneumatic pressure medium, namely compressed air.

In the example embodiment illustrated two valves 4 and 5 are associated with the shift cylinder 1, namely in such manner that one valve 4 or 5 is respectively associated with each chamber 2 or 3 of the shift cylinder 1. By means of the valves 4, 5 compressed air can either be supplied from a compressed air reservoir 6 to the chambers 2, 3 of the shift cylinder 1, or released from the chambers 2, 3. Whether compressed air is supplied to a chamber 2 or 3 of the shift cylinder 1 or released from it, is determined by the position of the corresponding valve 4, 5, the valves 4, 5 in the example embodiment shown being so-termed 3/2 valves with three connections for compressed air and two valve positions. In a first valve position of the valves 4 and 5 compressed air can be supplied to the corresponding chambers 2 or 3 of the shift cylinder 1, whereas in contrast, in a second valve position the compressed air is released from the chambers 2, 3.

The valve position adopted by the valves 4 and 5 for the pneumatic actuation of the shift cylinder 1 is determined with the help of a control system 7 according to the invention, this control system 7 serving to control the valves 4 and 5 associated with the shift cylinder 1. According to FIG. 1 the control system 7 emits a respective output signal 8 or 9 for each valve 4 or 5, these output signals 8 or 9 from the control system 7 according to the invention constituting effective control measures for the respective valve 4 or 5 in the sense of the necessary electric energizing thereof.

The control system 7 according to the invention comprises devices of a first type 10, 11 and 12 with the help of which, at the same time or in parallel for a plurality of function demands of the shift cylinder 1, corresponding valve requirements 13a, 14a, 15a for the valve 4 and corresponding valve requirements 13b, 14b, 15b for the valve 5 of the shift cylinder 1 can be calculated.

Thus for example, for the function demand to switch off the cylinder corresponding valve requirements 13a and 13b can be calculated for the two valves 4 and 5 by the device 10 of the first type. With the help of the device 11 of the first type, corresponding valve requirements 14a and 14b can preferably be calculated for the two valves 4 and 5 for the function demand to switch on the cylinder. In contrast, corresponding valve requirements 15a and 15b can be calculated for the two valves 4 and 5 by the device 12 of the first type for the function demand of cylinder confirmation. All the valve requirements 13a, 14a, 15a, 13b, 14b and 15b for the valves 4 and 5 of the shift cylinder 1 are calculated at the same time or in parallel with the help of the devices of the first type 10, 11 and 12.

According to FIG. 1, besides the valve requirements 13a, 14a, 15a, 13b, 14b and 15b related to the function demands to switch off the cylinder, to switch on the cylinder and to confirm the cylinder, the control system 7 according to the invention calculates, at the same time or in parallel, further valve requirements 16a and 16b which, in the example embodiment of FIG. 1, relate to a function demand for interruption.

Besides the devices 10, 11 and 12 of the first type with whose help the valve requirements for the valves 4 and 5 can be calculated at the same time or in parallel, the control system 7 according to the invention also comprises two devices 17 and 18 which, for each valve 4 or 5, determine from the valve requirements calculated in parallel the effective control measure 8 or 9 individually for the valve 4 or 5 concerned.

Thus, in the example embodiment illustrated in FIG. 1, one such device 17 or 18 of the second type is associated with each valve 4 or 5, and each of these devices 17 or 18 of the second type logically links the valve requirements 13a, 14a, 15a or 13b, 14b, 15b calculated for the respective valve 4 or 5. Accordingly, the devices 17 and 18 of the second type comprise logical operators, in the example embodiment illustrated the logical operators 19, 20 and 21.

The logical operators 19, 20 and 21 of the respective devices of the second type determine, by logical linking of the valve requirements 13a, 14a, 15a or 13b, 14b, 15b calculated at the same time for the respective valve 4 or 5, the respective effective control measure 8 or 9 for the valve 4 or 5 concerned. In the example embodiment shown the logical operators 19 are OR-operators, the logical operators 20 are NOT-operators and the logical operators 21 are AND-operators.

Accordingly, with the help of the control system according to the invention several function demands can be processed at the same time and therefore in parallel for one shift cylinder and corresponding valve requirements can be calculated for these function demands. From the valve requirements calculated for each valve, by logical linking an effective control measure is determined for the shift cylinder valve concerned. In this way function gaps can be avoided and overlaps of function demands are enabled by the valve control system.

With reference to FIG. 1 the invention has been described in the context of the preferred example embodiment of a shift cylinder with two chambers, each chamber being associated with a 3/2 valve. It should be made clear, however, that the invention is not limited to this arrangement, but rather, can also be used with cylinders having two chambers each of which is associated with two 2/2 valves. Likewise, the invention can be used with cylinders having one chamber, and in the case of a cylinder with one chamber restoration is effected by means of a spring element integrated in the cylinder.

### INDEXES

1 Shift cylinder

2 Chamber

3 Chamber

4 Valve

5 Valve

6 Compressed air reservoir

7 Control system

8 Effective control measure

9 Effective control measure

10 Device of the first type

11 Device of the first type

12 Device of the first type

13a, 13b Valve requirement

14a, 14b Valve requirement

15a, 15b Valve requirement

16a, 16b Valve requirement

17 Device of the second type

18 Device of the second type

19 Logical operator

20 Logical operator

21 Logical operator

1-6. (canceled)

7. A control system for one of a pneumatically and a hydraulically actuated shift cylinder (1) of a transmission or transmission-related auxiliary drive output, namely, for controlling at least one valve (4, 5) associated with the shift cylinder (1), such that at least one shift position of the shift cylinder is produced by the at least one valve (4, 5), the control system comprises:
devices of a first type (10, 11, 12) with which valve requirements corresponding to a plurality of functions, which are demanded from the shift cylinder (1), are calculated at the same time or in parallel for the at least one valve (4, 5);
devices of a second type (17, 18) which logically link the valve requirements calculated for the at least one valve (4, 5) such that, from the valve requirements calculated in parallel for the respective valve (4, 5), the devices of the second type (17, 18) determine an effective control measure (8, 9) for the at least one valve (4, 5).

8. The control system according to claim 7, wherein the devices of the first type (10, 11, 12) calculate, at the same time of calculating corresponding valve requirements (13a, 14a, 15a, 13b, 14b, 15b) for the at least one valve (4, 5), at least one of a functional demand to switch off, to switch on and confirm the shift cylinder (1).

9. The control system according to claim 7, wherein the devices of the second type (17, 18) comprise logical operators which determine an effective control measure (8, 9) for the at least one valve (4, 5) by logically linking the valve requirements calculated simultaneously for the at least one valve (4, 5).

10. The control system according to claim 9, wherein the logical operators include at least one of OR-operators and AND-operators.

11. The control system according to claim 7, wherein the shift cylinder (1) comprises two chambers (2, 3) and a valve (4, 5) associated with each of the two chambers (2, 3), the devices of the first type (10, 11, 12) for each valve (4, 5) simultaneously calculate corresponding valve requirements for a plurality of functions demanded of the shift cylinder (1), and the devices of the second type (17, 18) individually calculate, for each valve (4, 5) of the shift cylinder (1) logically linked, the calculated valve requirements to determine an effective control measure (8, 9) for each valve (4, 5).

12. The control system according to claim 11, wherein a 3/2 valve is associated with each chamber (2, 3) of the shift valve (4, 5).
